(19) United States
(12) Patent Application Publication
(10) Pub. No.: US 2006/0198522 A1
(43) Pub. Date: Sep. 7, 2006

(54) Wide band-DCSK modulation method, transmitting apparatus thereof, wide band-DCSK demodulation method, and receiving apparatus thereof

(75) Inventors: Chia chin Chong, Yongin-si (KR); Su khiong Yong, Yongin-si (KR); Seong-soo Lee, Suwon-si (KR); Young-hwan Kim, Taean-eup (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/368,630

(22) Filed: Mar. 7, 2006

(30) Foreign Application Priority Data
Mar. 7, 2005 (KR) 2005-0018683

(51) Int. Cl. H04L 9/00

(52) U.S. Cl. 380/263

(57) ABSTRACT

Provided are a wide band-differential chaos shift keying modulation method, a transmitting apparatus adopting the wide band-differential chaos shift keying modulation method, a wide band-differential chaos shift keying demodulation method, and a receiving apparatus adopting the wide band-differential chaos shift keying demodulation method. The wide band-differential chaos shift keying modulation method includes: generating a wide band chaotic signal; delaying the wide band chaotic signal; multiplying the delayed wide band chaotic signal by an information signal to output a multiplied signal; and performing a switching operation so as to alternately transmit the wide band chaotic signal and the multiplied signal. Thus, the invention can be realized without an APLL, a mixer, an FM modulator, and the like, to reduce power consumption and manufacturing cost for the transmitting apparatus. Thus, noise characteristics and security performance can be high, and the wide band-DCSK modulation method can be robust to multi-path.

### CROSS-REFERENCE TO RELATED APPLICATIONS

This application claims the benefit of Korean Patent Application No. 2005-18683, filed on Mar. 7, 2005, in the Korean Intellectual Property Office, the disclosure of which is incorporated herein by reference.

### BACKGROUND OF THE INVENTION

1. Field of the Invention

Methods and apparatuses consistent with the present invention relate to modulation, demodulation, and more particularly, to wide band-DCSK modulation using a wide band chaotic signal that is a nonlinear signal.

2. Description of the Related Art

Modulation methods using chaotic signals have been discussed and will now be introduced.

An ultra wide band (UWB)-direct chaos on off keying (DCOOK) modulation method may be taken as an example of a modulation method using a chaotic signal. In the UWB-DCOOK modulation method, noise performance and multi-path characteristics are poor. Also, since the UWB-DCOOK modulation method is an asynchronous modulation method, multiple access is difficult.

A narrow band (NB)-differential chaos shift keying (DCSK) modulation method is another modulation method using a chaotic signal. The NB-DCSK modulation method is used for a narrow band communication system and thus, difficult to be applied to a wide band communication system such as a UWB communication system. Also, a mixer such as an analog phase locked loop (APLL) is required for modulation, which increases power consumption and manufacturing unit cost for a communication apparatus. Energy is not uniform in each transmitted symbol, and thus, an autocorrelation variance of a received signal increased. As a result, a reception performance of a receiver deteriorates.

An NB-frequency modulation (FM)-DCSK modulation method is another modulation method using a chaotic signal. The NB-FM-DCSK modulation method is a complement of the NB-DCSK modulation method in which an FM modulator is used to make energy uniform in each symbol. However, the NB-FM-DCSK modulation method is also used for a narrow band communication system and thus, difficult to be applied to a wide band communication system such as a UWB communication system. Also, the NB-FM-DCSK modulation method requires both of the FM modulator and a DCSK modulator, which increases power consumption and manufacturing unit cost for a communication apparatus.

### SUMMARY OF THE INVENTION

Accordingly, an aspect of the present general inventive concept is to provide a wide band-DCSK modulation method using a wide band chaotic signal so as to be applied to a wide band communication system, to reduce power consumption and manufacturing cost, to be robust to multi-path, and to enable multiple access transmitting apparatus adopting the wide band-DCSK modulation method, a wide band-DCSK demodulation method, and a receiving apparatus adopting the wide band-DCSK demodulation method.

According to an aspect of the present invention, there is provided a transmitting apparatus including: a chaotic signal generator generating and outputting a wide band chaotic signal; a delayer delaying and outputting the wide band chaotic signal output from the chaotic signal generator; a multiplier multiplying the delayed wide band chaotic signal output from the delayer by an information signal to output a multiplied signal; and a switching unit performing a switching operation so that the wide band chaotic signal generated by the chaotic signal generator and the multiplied signal output from the multiplier are alternately output.

The chaotic signal generator may generate the wide band chaotic signal matching with a predetermined reference power spectral density mask.

The chaotic signal generator may generate an ultra wide band chaotic signal.

The information signal may be an information signal coded by orthogonal codes.

The orthogonal codes may be Walsh codes or Gold codes.

The delayer may delay the wide band chaotic signal for T/2 and output the delayed wide band chaotic signal.

According to another aspect of the present invention, there is provided a wide band-differential chaos shift keying modulation method including: generating and outputting a wide band chaotic signal; delaying the wide band chaotic signal; multiplying the delayed wide band chaotic signal by an information signal to output a multiplied signal; and performing a switching operation so as to alternately transmit the wide band chaotic signal and the multiplied signal.

The wide band chaotic signal matching with a predetermined reference power spectral density mask may be generated.

The wide band chaotic signal may be an ultra wide band chaotic signal.

The information signal may be an information signal coded by orthogonal codes.

The orthogonal codes may be Wash codes or Gold codes.

The wide band chaotic signal may be delayed for T/2 and then output.

According to still another aspect of the present invention, there is provided a receiving apparatus including: a correlation unit correlating a modulation signal modulated using a wide band-differential chaos shift keying modulation method to output a correlation signal; and a detector detecting a level of the correlation signal output from the correlation unit to recover an information signal.

According to yet another aspect of the present invention, there is provided a wide band-differential chaos shift keying demodulation method including: correlating a modulation signal modulated using a wide band-differential chaos shift keying modulation method to output a correlation signal; and detecting a level of the correlation signal output from the correlation unit to recover an information signal.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a block diagram of a communication system including a transmitting apparatus performing a wide band-DCSK modulation and a receiving apparatus performing a wide band-DCSK demodulation according to an exemplary embodiment of the present invention;

FIG. 2A is a graph illustrating an autocorrelation variance of a UWB-DCSK communication system;

FIG. 2B is a graph illustrating an autocorrelation variance of an NB-DCSK communication system;

FIG. 3 is a graph illustrating noise performances of a UWB-DCSK communication system, a UWB-DCOOK communication system, and an NB-FM-DCSK communication system;

FIG. 4 is a flowchart of a method of a wide band-DCSK modulation method according to an exemplary embodiment of the present invention;

FIG. 5 is a waveform diagram for dilating the wide-band DCSK modulation method;

FIG. 6 is a flowchart of a wide band-DCSK demodulation method according to an exemplary embodiment of the present invention;

FIG. 7 is a waveform diagram for dilating the wide band-DCSK demodulation method.

### DETAILED DESCRIPTION OF THE EXEMPLARY EMBODIMENTS

Certain exemplary embodiments of the present invention will be described in greater detail with reference to the accompanying drawings.

In the following description, same drawing reference numerals are used for the same elements even in different drawings. The aspects defined in the description such as the detailed construction and the elements are nothing but the aspects provided to assist in a comprehensive understanding of the invention. Thus, it is apparent that the present invention can be carried out without those defined aspects. Also, well-known functions or constructions are not described in detail since they would obscure the invention in unnecessary detail.

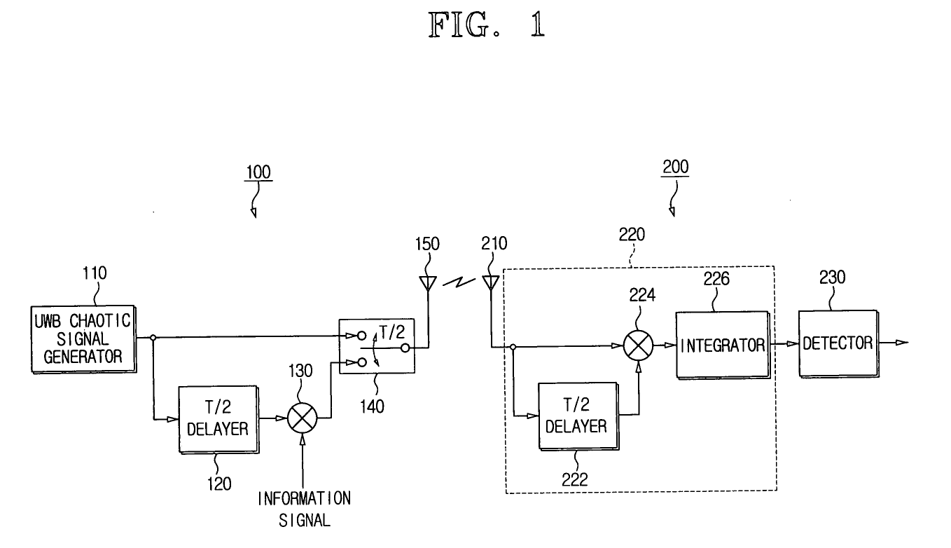

FIG. 1 is a block diagram of a communication system including transmitting and receiving apparatuses according to an exemplary embodiment of the present invention.

A transmitting apparatus 100 transmits an information signal using a wide band-DCSK modulation method using a wide band chaotic signal that is a nonlinear signal. The transmitting apparatus 100 includes a UWB chaotic signal generator 110, a T/2 delayer 120, a multiplier 130, a switching unit 140, and a transmission antenna 150.

The UWB chaotic signal generator 110 generates a UWB chaotic signal and outputs the UWB chaotic signal to the T/2 delayer 120 and the switching unit 140. The UWB chaotic signal generator 110 generates the UWB chaotic signal matching with a predetermined reference power spectral density (PSD) mask. Here, the predetermined reference PSD mask may be stipulated by the U.S. Federal Communications Commission.

The T/2 delayer 120 delays the UWB chaotic signal output from the UWB chaotic signal generator 110 for T/2 and outputs the delayed UWB chaotic signal to the multiplier 130.

The multiplier 130 multiplies the UWB chaotic signal output from the T/2 delayer 120 by an input information signal to generate a multiplied signal and outputs the multiplied signal to the switching unit 140.

Here, the information signal input to the multiplier 130 may be an information signal coded by orthogonal codes. Here, Walsh codes, Gold codes, or the like, may be applied.

The switching unit 140 performs a switching operation so that the UWB chaotic signal and the multiplied signal are alternately output from the switching unit 140. Here, the switching unit 140 performs the switching operation in every T/2.

In detail, the switching unit 140 performs the switching operation so that the UWB chaotic signal is output for a first T/2, the multiplied signal is output for a next T/2, the UWB chaotic signal is output for a next T/2, and so on and so forth.

A signal output from the switching unit 140 corresponds to a wide band-DCSK modulation signal that is transmitted to a receiving apparatus 200 through the transmission antenna 150.

The receiving apparatus 200 wide band-DCSK demodulates the wide band-DCSK modulation signal to recover the information signal. The receiving apparatus 200 includes a reception antenna 210, a correlation unit 220, and a detector 230.

The correlation unit 220 correlates the wide band-DCSK modulation signal received through the reception antenna 210 to generate a correlation signal and outputs the correlation signal to the detector 230. The correlation unit 220 includes a T/2 delayer 222, a multiplier 224, and an integrator 226.

The T/2 delayer 222 delays the wide band-DCSK modulation signal received through the reception antenna 210 for T/2 and outputs the delayed wide band-DCSK modulation signal to the multiplier 224.

The multiplier 224 multiplies the wide band-DCSK modulation signal received through the reception antenna 210 by the wide band-DCSK modulation signal output from the T/2 delayer 222 to generate a multiplied signal and outputs the multiplied signal to the integrator 226.

The integrator 226 integrates and outputs the multiplied signal output from the multiplier 224. The integrated signal output from the integrator 226 corresponds to the correlation signal that is output to the detector 230.

The detector 230 detects a level of the correlation signal output from the correlation unit 220 to output a signal of “0” or “1” so as to recover the information signal.

Energy of a transmitted signal per bit must be uniform to increase the reception performance of the receiving apparatus 200. If the energy of the transmitted signal per bit is not uniform, an autocorrelation variance of the receiving apparatus 200 is increased.

The autocorrelation variance in the receiving apparatus 200 is inversely proportional to a transmission bandwidth and a bit width. Thus, if the transmission bandwidth and the bit width are wide, the autocorrelation variance can be lowered. However, if the transmission bandwidth and the bit width are too wider, the noise performance may deteriorate.

Thus, the transmission bandwidth and the bit width must be properly determined in consideration of the above described two points. The transmission bandwidth may be 2 GHz (between 3.1 and 5.1 GHz) and the bit width may be 200 ns so as to lower the autocorrelation variance in the receiving apparatus 200 and so as not to deteriorate the noise performance.

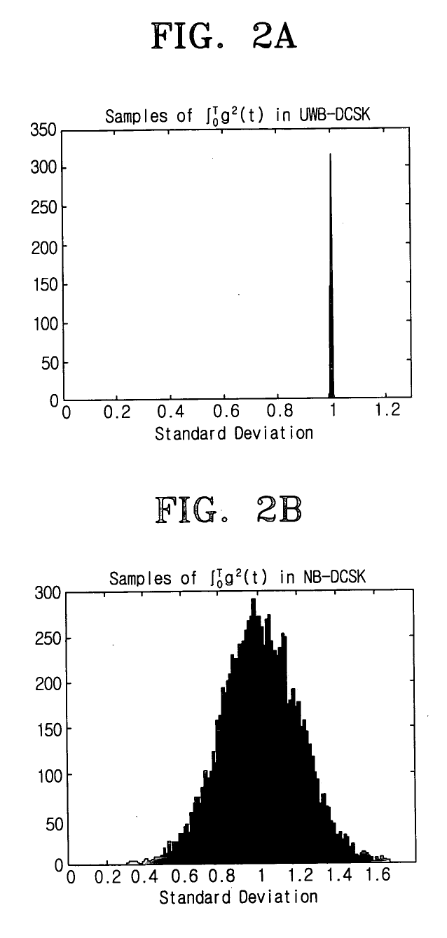

FIG. 2A is a graph illustrating an autocorrelation variance of a UWB-DCSK communication system under the above-described conditions. The autocorrelation variance of the UWB-DCSK communication system shown in FIG. 2A is much smaller than an autocorrelation variance of an NB-DCSK communication system shown in FIG. 2B.

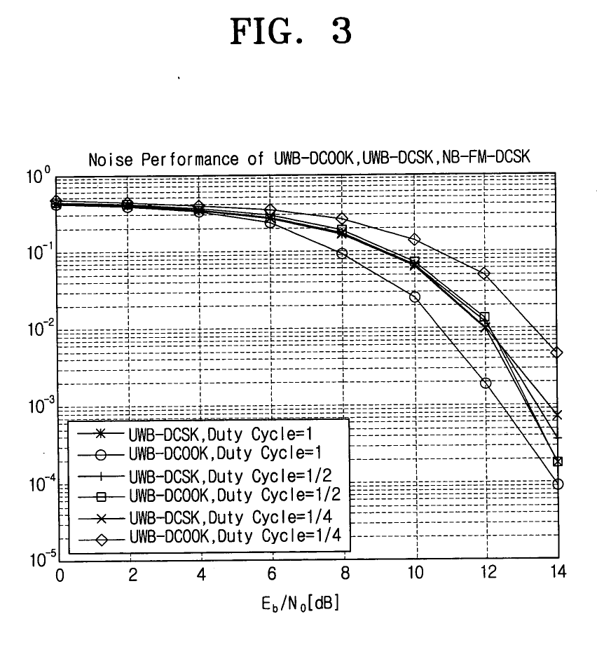

FIG. 3 is a graph illustrating noise performance of the UWB-DCSK communication system together with noise performances of UWB-DCOOK and NB-FM-DCSK communication systems under the above-described conditions. Referring to FIG. 3, the noise performance of the UWB-DCSK communication system is equivalent to the noise performance of the NB-FM-DCSK communication system but superior to the noise performance of the UWB-DCOOK communication system.

An information signal coded by orthogonal codes is used to improve a demodulation performance of the receiving apparatus 200. Since a cross correlation is “0” and an autocorrelation is “1,” the orthogonal codes are used.

Also, if the information signal coded by the orthogonal codes is used, multiple access through which a plurality of users can use a frequency band is possible.

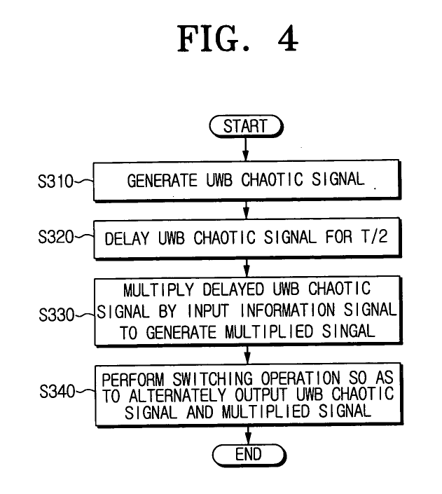

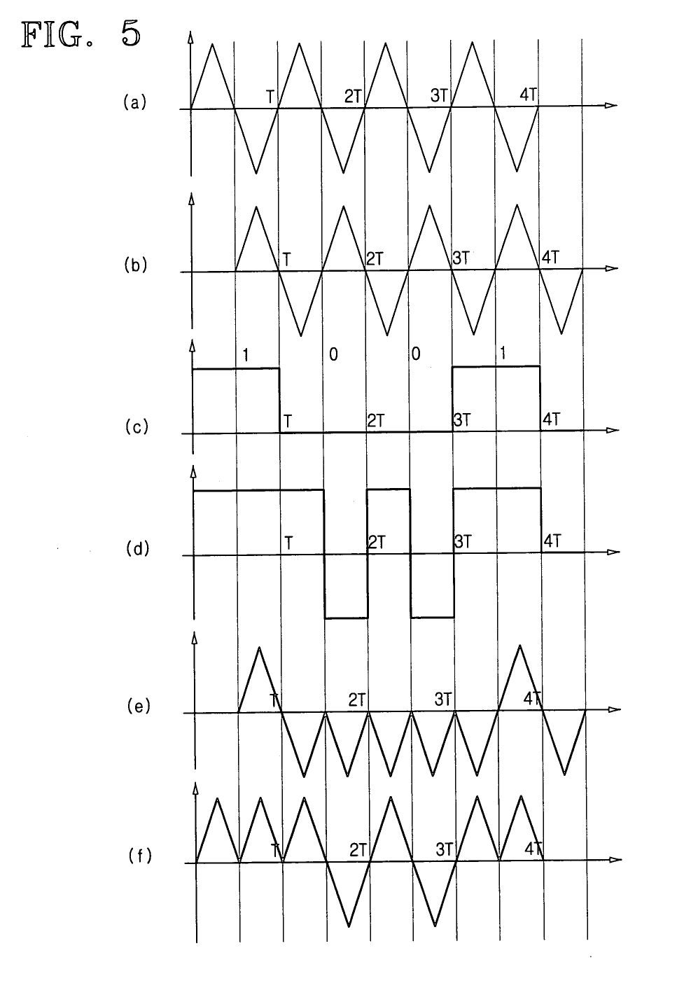

A wide band-DCSK modulation process performed by the transmitting apparatus 100 will now be described in detail with reference to FIGS. 4 and 5. FIG. 4 is a flowchart of a wide band-DCSK modulation method according to an exemplary embodiment of the present invention, and FIG. 5 is a waveform diagram for dilating the wide band-DCSK modulation method.

Referring to FIG. 4, in operation S310, the UWB chaotic signal generator 110 of the transmitting apparatus 100 generates a UWB chaotic signal. The UWB chaotic signal generated in operation S310 is a UWB chaotic signal matching with a predetermined reference PSD mask. Also, a transmission bandwidth may be 2 GHz (between 3.1 GHz and 5.1 GHz), and a bit width may be 200 ns.

The UWB chaotic signal generated by the UWB chaotic signal generator 110 is simply shown in (a) of FIG. 5.

In operation S320, the T/2 delayer 120 delays the UWB chaotic signal generated by the UWB chaotic signal generator 110 for T/2. The UWB chaotic signal delayed by the T/2 delayer 120 is shown in (b) of FIG. 5.

In operation S330, the multiplier 130 multiplies the UWB chaotic signal delayed by the T/2 delayer 120 by an input information signal to generate a multiplied signal. The information signal input in operation S330 may be coded by orthogonal codes such as Walsh codes, Gold codes, or the like.

“1 0 0 1” as the information signal is shown in (c) of FIG. 5. Also, (d) of FIG. 5 shows an information signal coded by the Walsh codes so as to code “1” into [1 1] and “0” into [1 −1]. (e) of FIG. 5 shows the multiplied signal generated by multiplying the delayed UWB chaotic signal shown in (b) of FIG. 5 by the information signal shown in (d) of FIG. 5.

In operation S340, the switching unit 140 performs a switching operation so as to alternately output the UWB chaotic signal generated by the UWB chaotic signal generator 110 and the multiplied signal generated by the multiplier 130. The switching unit 140 performs the switching operation at every T/2.

(f) of FIG. 5 shows a wide band-DCSK modulation signal generated by the switching operation to alternately output the UWB chaotic signal shown in (a) of FIG. 5 and the multiplied signal shown in (e) of FIG. 5. In detail, the switching operation is performed so that the UWB chaotic signal is output for a first T/2, the multiplied signal is output for a next T/2, the UWB chaotic signal is output for a next T/2, and so on and so forth.

The wide band-DCSK modulation signal output from the switching unit 140 is transmitted to the receiving apparatus 200 through the transmission antenna 150.

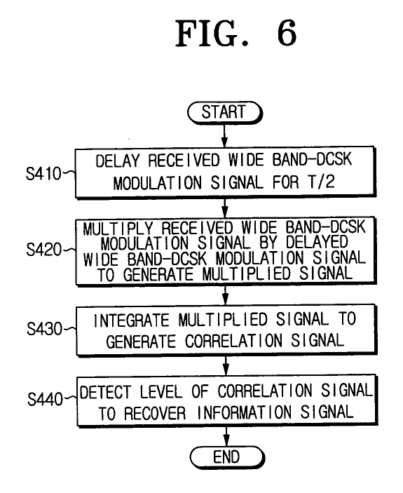

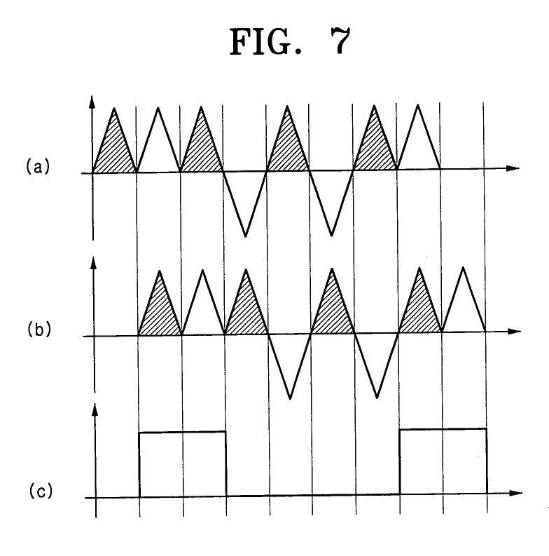

A wide band-DCSK demodulation process performed by the receiving apparatus 200 will now be described in detail with reference to FIGS. 6 and 7. FIG. 6 is a flowchart of a wide band-demodulation method according to an exemplary embodiment of the present invention, and FIG. 7 is a waveform diagram for dilating the wide band-DCSK demodulation method.

Referring to FIG. 6, in operation S410, the T/2 delayer of the correlation unit 220 of the receiving apparatus 200 delays a wide band-DCSK modulation signal received through the reception antenna 210 for T/2.

(a) of FIG. 7 shows the wide band-DCSK modulation signal received through the reception antenna 210 equal to that shown in (f) of FIG. 5. (b) of FIG. 7 shows the wide band-DCSK modulation signal delayed by the T/2 delayer 222. Portions of (a) and (b) of FIG. 7 marked with slanted lines correspond to a reference signal, and the other portions correspond to an information signal.

In operation S420, the multiplier 224 multiplies the wide band-DCSK modulation signal received through the reception antenna 210 by the wide band-DCSK modulation signal output from the T/2 delayer 222 to generate a multiplied signal. In operation S430, the integrator 226 integrates the multiplied signal output from the multiplier 224. The integrated signal output from the integrator 226 corresponds to a correlation signal.

(c) of FIG. 7 shows the correlation signal output from the integrator 226, the correlation signal being equal to a signal generated by delaying the information signal shown in (c) of FIG. 5 for T/2.

In operation S440, the detector 230 detects a level of the correlation signal output from the integrator 226 to output a signal of “0” or “1” so as to recover the information signal.

The wide band-DCSK modulation and demodulation methods have been described. The wide band-DCSK modulation and demodulation methods can be applied to a wide band communication system, particularly to a UWB communication system.

As described above, a wide band-DCSK modulation method, a transmitting apparatus adopting the wide band-DCSK modulation method, a wide band-DCSK demodulation method, and a receiving apparatus adopting the wide band-DCSK demodulation method according to the present invention can be realized without an APLL, a mixer, an FM modulator, and the like. Thus, power consumption can be reduced, and manufacturing cost for the transmitting apparatus can be lowered.

Also, the wide band-DCSK modulation method can be performed using a wide band chaotic signal. Thus, noise characteristics and security performance can be high, and the wide band-DCSK modulation method can be robust to multi-path.

In addition, an information signal coded by orthogonal codes can be used. Thus, a demodulation performance of the receiving apparatus can be improved, and multiple access is possible.

The foregoing exemplary embodiment and aspects are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A transmitting apparatus, comprising:
a chaotic signal generator generating and outputting a wide band chaotic signal;
a delayer delaying and outputting the wide band chaotic signal to generate a delayed wide band chaotic signal;
a multiplier multiplying the delayed wide band chaotic signal by an information signal to output a multiplied signal; and
means for alternately outputting the wide band chaotic signal and the multiplied signal.

2. The apparatus of claim 1, wherein the chaotic signal generator generates the wide band chaotic signal matching with a predetermined reference power spectral density mask.

3. The apparatus of claim 2, wherein the chaotic signal generator generates an ultra wide band chaotic signal.

4. The apparatus of claim 1, wherein the information signal is an information signal coded by orthogonal codes.

5. The apparatus of claim 4, wherein the orthogonal codes are Walsh codes or Gold codes.

6. The apparatus of claim 1, wherein the delayer delays the wide band chaotic signal for a T/2 and outputs the delayed wide band chaotic signal.

7. The apparatus of claim 1, wherein the means for alternately outputting the wide band chaotic signal and the multiplied signal comprises a switching unit.

8. A wide band-differential chaos shift keying modulation method, comprising:
generating and outputting a wide band chaotic signal;
delaying the wide band chaotic signal to generate a delayed wide band chaotic signal;
multiplying the delayed wide band chaotic signal by an information signal to output a multiplied signal; and
alternately transmitting the wide band chaotic signal and the multiplied signal.

9. The method of claim 8, wherein the wide band chaotic signal matching with a predetermined reference power spectral density mask is generated.

10. The method of claim 9, wherein the wide band chaotic signal is an ultra wide band chaotic signal.

11. The method of claim 8, wherein the information signal is an information signal coded by orthogonal codes.

12. The method of claim 11, wherein the orthogonal codes are Wash codes or Gold codes.

13. The method of claim 8, wherein the wide band chaotic signal is delayed for a T/2 and then output.

14. The method of claim 8, wherein the alternately transmitting comprises switching between the wide band chaotic signal and the multiplied signal.

15. A receiving apparatus comprising:
a correlation unit correlating a modulation signal modulated using a wide band-differential chaos shift keying modulation method to output a correlation signal; and
a detector detecting a level of the correlation signal output from the correlation unit to recover an information signal.

16. A wide band-differential chaos shift keying demodulation method comprising:
correlating a modulation signal modulated using a wide band-differential chaos shift keying modulation method to output a correlation signal; and
detecting a level of the correlation signal output from the correlation unit to recover an information signal.
